(19) United States
(12) Patent Application Publication
(10) Pub. No.: US 2024/0281712 A1
(43) Pub. Date: Aug. 22, 2024

(54) LEARNING METHOD

(71) Applicant: NEC Corporation, Minato-ku, Tokyo (JP)

(72) Inventors: Yuji KOBAYASHI, Tokyo (JP); Yoshiaki SAKAE, Tokyo (JP); Hiroki TAGATO, Tokyo (JP); Takashi KONASHI, Tokyo (JP); Jun NISHIOKA, Tokyo (JP); Jun KODAMA, Tokyo (JP); Etsuko ICHIHARA, Tokyo (JP)

(73) Assignee: NEC Corporation, Minato-ku, Tokyo (JP)

(21) Appl. No.: 18/566,795

(22) PCT Filed: Jun. 7, 2021
(86) PCT No.: PCT/JP2021/021629

§ 371 Date: Dec. 4, 2023

(51) Int. Cl. G06N 20/00

(52) U.S. Cl. CPC G06N 20/00

(57) ABSTRACT

A learning device 100 according to this invention includes: a classification unit 121 configured to classify measurement value data measuring performance of an object on the basis of situation data each representing a situation of the object when the measurement value data are measured; a selection unit 122 configured to select the measurement value data from each of the classifications according to the number of the measurement value data for each of the classifications; and a learning unit 123 configured to perform machine learning on the basis of the selected measurement value data.

### TECHNICAL FIELD

The present invention relates to a learning method, a learning device, and a program, according to a situation in which a device is placed.

### BACKGROUND ART

Systems of vehicles, computer products, and industrial plants analyze measurement data detected from various sensors installed in the systems, and detect abnormal states of the systems from results of such analysis. In this case, the measurement data are analyzed using a model that has learned the measurement data detected from the systems in a normal state and accumulated in advance as training data. More specifically, when abnormal states of the systems are detected, it is required to generate an abnormal detection model using the training data measured in advance from the systems operating in a normal state.

### CITATION LIST

### PATENT LITERATURE

### Patent Literature 1: JP 2020-113216 A

### SUMMARY OF INVENTION

### TECHNICAL PROBLEM

Herein, the training data used for the learning are measured when the systems are operating, but the systems operate in various environments. However, the systems have different operating situations depending on the environment, and the measurement data in a normal state also vary depending on the environment. Therefore, it is desirable to randomly sample the training data from the systems normally operating in every environment. However, due to scarce apperance of situations in some environments, the number of acquirable data is small, making it difficult to equally extract the training data from every environment. As a result, there arises a problem of inability to generate a highly accurate abnormal detection model.

In Patent Literature 1, alerts occurring in the systems are classified, and the number of training data extracted from the classifications is adjusted. However, the alerts are generated by the training data, and the number to be extracted is merely adjusted according to the contents of the training data themselves. As a result, there still remains the problem that the training data cannot be equally extracted from situations in which the systems are operating, making it impossible to generate the highly accurate abnormal detection model. Further, there arises a problem of difficulty in generating a state detection model for not only detecting an abnormal state but detecting a specific state.

Therefore, it is an object of the present invention to provide a learning method capable of solving the above-described problem of inability to generate the highly accurate state detection model.

### SOLUTION TO PROBLEM

A learning method according to one aspect of the present invention includes:
classifying measurement value data measuring performance of an object on the basis of situation data each representing a situation of the object when the measurement value data are measured,
selecting the measurement value data from each of the classifications according to the number of the measurement value data for each of the classifications, and
performing machine learning on the basis of the selected measurement value data.

A learning device according to one aspect of the present invention includes:
a classification unit configured to classify measurement value data measuring performance of an object on the basis of situation data each representing a situation of the object when the measurement value data are measured;
a selection unit configured to select the measurement value data from each of the classifications according to the number of the measurement value data for each of the classifications; and
a learning unit configured to perform machine learning on the basis of the selected measurement value data.

A computer-readable medium storing thereon a program for causing a computer to execute processing to:
classify measurement value data measuring performance of an object on the basis of situation data each representing a situation of the object when the measurement value data are measured;
select the measurement value data from each of the classifications according to the number of the measurement value data for each of the classifications; and
perform machine learning on the basis of the selected measurement value data.

### ADVANTAGEOUS EFFECTS OF INVENTION

With the configurations described above, the present invention enables the generation of the highly accurate state detection model.

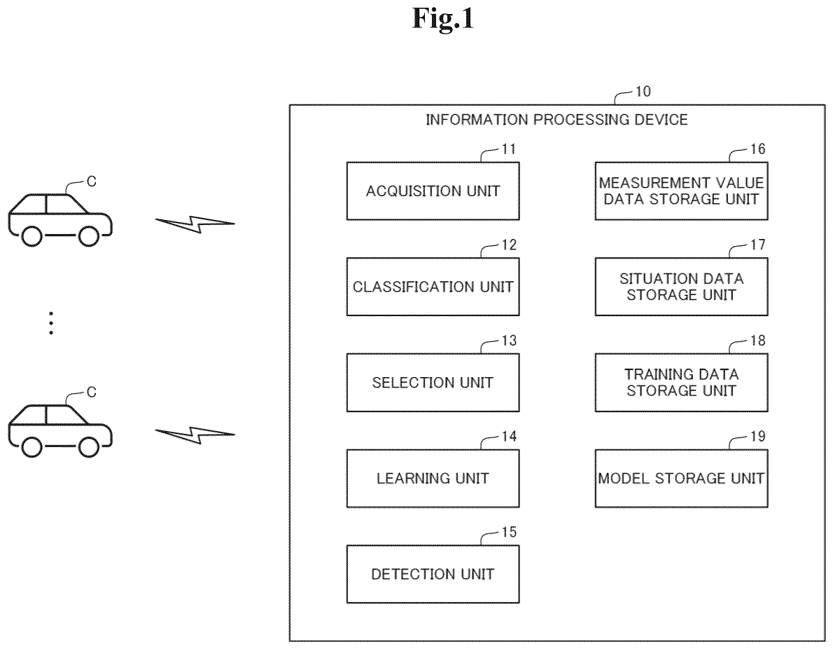

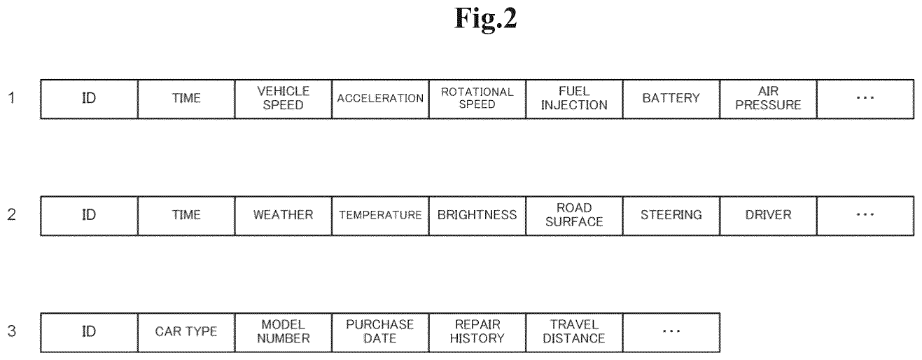

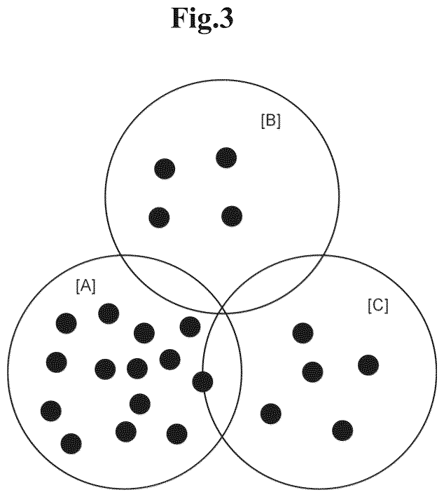

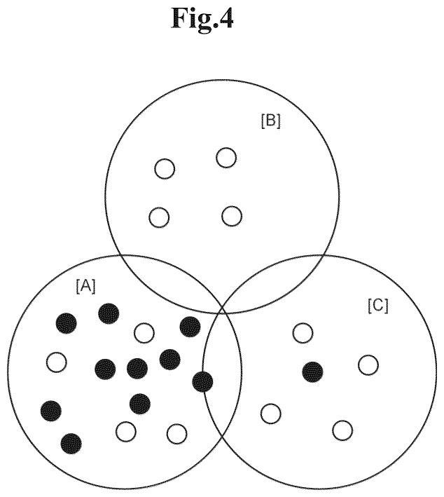

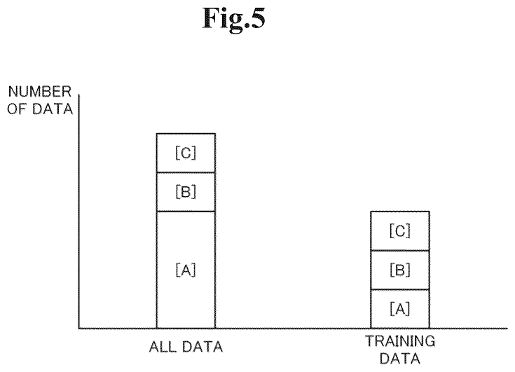

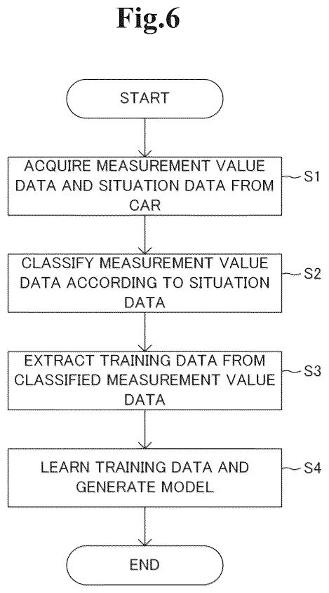

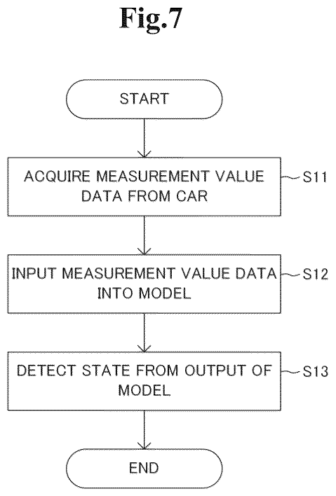

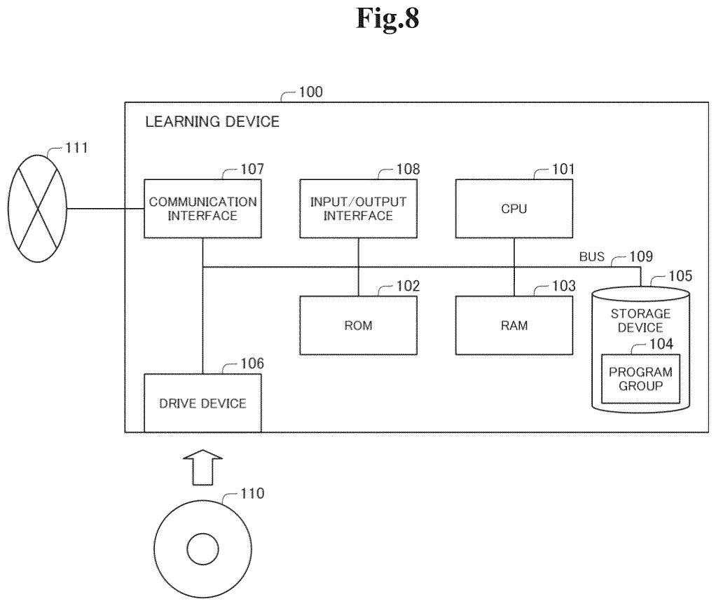

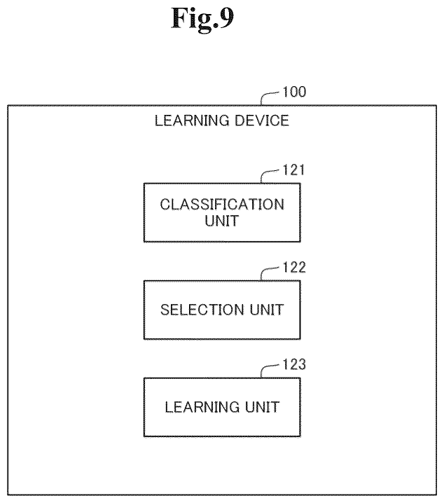

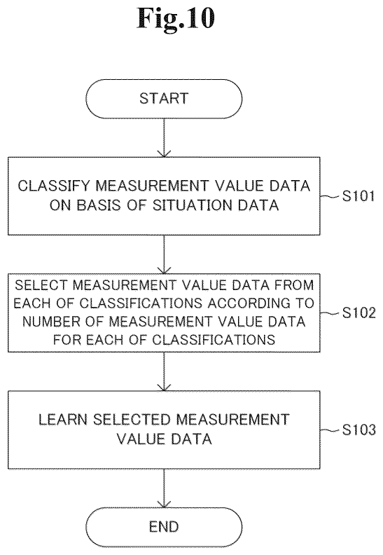

### BRIEF DESCRIPTION OF DRAWINGS

[FIG. 1] FIG. 1 is a block diagram illustrating a configuration of an information processing device in a first exemplary embodiment of the present invention.

[FIG. 2] FIG. 2 is a diagram illustrating an example of data to be processed by the information processing device disclosed in FIG. 1.

[FIG. 3] FIG. 3 is a diagram illustrating a state of data processing by the information processing device disclosed in FIG. 1.

[FIG. 4] FIG. 4 is a diagram illustrating a state of data processing by the information processing device disclosed in FIG. 1.

[FIG. 5] FIG. 5 is a diagram illustrating a state of data processing by the information processing device disclosed in FIG. 1.

[FIG. 6] FIG. 6 is a flowchart illustrating an operation of the information processing device disclosed in FIG. 1.

[FIG. 7] FIG. 7 is a flowchart illustrating an operation of the information processing device disclosed in FIG. 1.

[FIG. 8] FIG. 8 is a block diagram illustrating a hardware configuration of an information processing device in a second exemplary embodiment of the present invention.

[FIG. 9] FIG. 9 is a block diagram illustrating a configuration of the information processing device in the second exemplary embodiment of the present invention.

[FIG. 10] FIG. 10 is a flowchart illustrating an operation of the information processing device in the second exemplary embodiment of the present invention.

### DESCRIPTION OF EMBODIMENTS

### <First Exemplary Embodiment>

A first exemplary embodiment of the present invention will be described with reference to FIGS. 1 to 7. FIGS. 1 and 2 are diagrams for explaining a configuration of an information processing device. FIGS. 3 to 7 are diagrams for explaining processing operations of the information processing device.

### [Configuration]

An information processing device 10 in the present invention functions as a learning device learning measurement value data measured from an object, and generates a state detection model detecting the state of the object. The information processing device 10 functions as a state detection device detecting the state of the object from measurement value data newly measured from the object using the generated state detection model.

In particular, the object is set to a car C in this exemplary embodiment. Therefore, the information processing device 10 has a function of learning measurement value data measuring performance of equipment equipped in the car C, and generating a state detection model detecting an abnormal state of the car C. Further, the information processing device 10 has a function of inputting the measurement value data newly measured from the car C into the state detection model, thereby detecting whether the car C is in an abnormal state from an output of the model. However, the state detection model generated by the information processing device 10 is not necessarily limited to one detecting an abnormal state of the car C, and may be one detecting any state of the car C. Further, the object whose state is to be detected is not necessarily limited to the car, and may be anything such as plants including computer devices, manufacturing factories, processing facilities, and the like.

The information processing device 10 is configured of one or a plurality of information processing devices each having an arithmetic device and a storage device. As illustrated in FIG. 1, the information processing device 10 includes an acquisition unit 11, a classification unit 12, a selection unit 13, a learning unit 14, and a detection unit 15. The functions of the acquisition unit 11, the classification unit 12, the selection unit 13, the learning unit 14, and the detection unit 15 can be realized by execution of programs for realizing the functions stored in the storage device by the arithmetic device. Further, the information processing device 10 includes a measurement value data storage unit 16, a situation data storage unit 17, a training data storage unit 18, and a model storage unit 19. The measurement value data storage unit 16, the situation data storage unit 17, the training data storage unit 18, and the model storage unit 19 are configured of storage devices. Each configuration will be described in detail below.

The acquisition unit 11 acquires the measurement value data measured by various sensors installed in the car C and stores the measurement value data in the storage unit 16. For example, the measurement value data are data that are values each representing the performance of each of a plurality of pieces of equipment equipped in the car C and that are measured by the various sensors at predetermined time intervals. As an example, the measurement value data include a vehicle speed, an acceleration, an engine speed, a fuel injection amount, a remaining battery level, and a tire pressure as measurement values each representing the performance of various devices mounted in the car C. However, the measurement value data may be a measurement value of any equipment insofar as the value represents the performance of the car C. The acquisition unit 11 may acquire the measurement value data accumulated in the car C together with time data from the car C or the measurement value data transmitted together with the time data from the car C for each measurement in the car C. Then, the acquisition unit 11 stores the acquired measurement value data in the measurement value data storage unit 16 in association with identification information (ID) identifying the car C and the time data as illustrated in FIG. 2(1). In this exemplary embodiment, the measurement value data acquired by the acquisition unit 11 are data when an operating state of the car C is a normal state, and may be data measured when the car C is in a specific operation state.

Further, the acquisition unit 11 acquires situation data each representing a situation of the car C when the above-described measurement value data are measured, and stores the situation data in the situation data storage unit 17. For example, the situation data are data each representing a situation of the car C due to an external situation of the car C (hereinafter, situation data related to the external situation of the car are also referred to as “external situation data”). As an example, the external situation data include weather, a temperature, brightness, a time zone, and a road surface situation as the situation due to an external environment where the car C is placed. Further, the external situation data include a steering direction and dozing as situations due to situations of a driver (operator) steering the car C. These situation data are acquired from the various sensors equipped in the car C. For example, the weather, the brightness, the road surface situation, and the like can be detected from image data acquired from a camera outside the car, the steering direction can be detected from data acquired from a steering angle sensor, and the dozing of the driver can be detected from image data imaging the driver acquired from an in-vehicle camera. However, the situation data may be any data insofar as the data includes contents representing the situations of the car C. For example, the situation data may be data each representing the situation of the car due to the state or an internal situation of the car itself and may be data such as a car type, a model number, a purchase date, a repair history, and a total travel distance of the car C (hereinafter, data each representing the situation of the car due to the state or the internal situation of the car itself are also referred to as “internal situation data”). The acquisition unit 11 may acquire the situation data accumulated in the car C together with the time data or may acquire the situation data transmitted together with the time data for each detection in the car C. Then, the acquisition unit 11 stores the acquired situation data in the situation data storage unit 17 in association with the identification information (ID) identifying the car C and the time data as illustrated in FIGS. 2(2) and 2(3). In this exemplary embodiment, the situation data acquired by the acquisition unit 11 are data when the operation state of the car C is a normal state, and may be data acquired when the car C is in a specific operation state.

When the state detection model is generated as described later, and the state of the car C is detected using such a model, the acquisition unit 11 acquires the measurement value data newly measured by the car C from the car C, and then gives the measurement value data to the detection unit 15. At this time, the acquisition unit 11 does not acquire the situation data, and acquires only the measurement value data and give the measurement value data to the detection unit 15.

The classification unit 12 classifies the measurement value data stored in the measurement value data storage unit 16 on the basis of the situation data stored in the situation data storage unit 17. More specifically, the classification unit 12 classifies the measurement value data for each situation of the car C specified by the situation data. At this time, the classification unit 12 makes the measurement value data and the situation data, with which the associated ID and time data match, correspond to each other as the data acquired by the same car C at the same time. Then, the classification unit 12 creates a classification for each content of the situation data, and sorts and classifies the measurement value data, which are made to correspond to the situation data corresponding to each of the classifications, so as to belong to each of the classifications. As an example, it is supposed that the classification unit 12 creates a classification A in which the situation data is “Weather: clear”, a classification B in which the situation data is “Road surface: bad road”, and a classification C in which the situation data is “Driver: dozing”. In this case, the classification unit 12 classifies the measurement value data made to correspond to the classifications A, B, and C as indicated by black circles in FIG. 3. Although only the three classifications are created above, the classification unit 12 may create classifications for all of the contents of the situation data and assign the measurement value data to the created classifications for classification.

The selection unit 13 selects the measurement value data to be used as the training data from among the measurement value data classified for each of the classifications as described above, and stores the measurement value data in the training data storage unit 18. At this time, the selection unit 13 selects the measurement value data from each of the classifications as the training data according to the number of the measurement value data for each of the classifications. For example, the selection unit 13 selects the measurement value data from each of the classifications such that the numbers are equal.

As an example, a case is described in which the measurement value data are classified as indicated by the black circles in FIG. 3 described above. First, in FIG. 3, the measurement value data in the classification A are the measurement value data corresponding to the situation data of “Weather: clear”, and the number of the measurement value data is large. On the other hand, the measurement value data in the classification B are the measurement value data corresponding to the situation data of “Road surface: bad road” and the measurement value data in the classification C are the measurement value data corresponding to the situation data of “Driver: dozing”, and therefore the situation indicated in the situation data are unlikely to appear, so that the number of the measurement value data is small. In such a case, the selection unit 13 selects the same number (for example, four each) of the measurement value data from each of the classifications A, B, and C as the training data as indicated by white circles in FIG. 4. More specifically, as illustrated in FIG. 5, although the number of the measurement value data belonging to each of the classifications A, B, and C is different, the number of the measurement value data selected as the training data is the same in each of the classifications A, B, and C. For example, the selection unit 13 sets the minimum value of the measurement value data among the classifications as the number of selections, and selects the measurement value data of the number corresponding to the set minimum value from each of the classifications. The selection unit 13 is not limited to selecting exactly the same number of the measurement value data from each of the classifications, and may select the measurement value data of the number that is determined to be substantially the same number (substantially equal) within a preset range.

However, the selection unit 13 is not necessarily limited to substantially equally selecting the measurement value data from each of the classifications. For example, the selection unit 13 may receive an input of a ratio of the number of the measurement value data to be selected set for each of the classifications, and may select the measurement value data from each of the classifications according to the ratio. As an example, when a ratio of “Classification A: Classification B: Classification C=2:1:1” is set, the selection unit 13 performs the selection such that the number of the measurement value data selected from each of the classifications satisfies the set ratio. The ratio may be input and set by an operator or the like or may be calculated and set by the selection unit 13 according to a distribution or the number of the measurement value data for each of the classifications. For example, the selection unit 13 may perform the setting such that the wider the distribution of the measurement value data belonging to the classification, the higher the ratio.

The learning unit 14 performs machine learning on the basis of the training data selected from each of the classifications and stored in the training data storage unit 18 as described above, and stores the state detection model generated as a result of the learning in the model storage unit 19. At this time, the learning unit 14 collectively learns all the training data selected from each of the classifications. More specifically, the learning unit 14 learns only the measurement value data without including the situation data. For each addition of the measurement value data, the learning unit 14 may additionally learn the training data selected from the measurement value data as describe above and update the state detection model. Herein, the training data to be learned are the measurement value data measured when the car C is in a normal state. Therefore, the state detection model generated by the learning is configured to detect whether the car C is in a normal state or an abnormal state. However, when the measurement value data measured from the car C are measured when the car C is in a predetermined specific state, a model is generated which detects whether the car C is in such a specific state.

The detection unit 15 detects the state of the car C using the state detection model stored in the model storage unit 19. Specifically, the detection unit 15 acquires the measurement value data newly measured by the car C via the acquisition unit 11, and inputs such measurement value data into the state detection model. Then, the detection unit 15 detects the state of the car C according to an output result of the state detection model. For example, the detection unit 15 detects whether the car C is in a normal state or an abnormal state. When the detection unit 15 detects that the car C is in an abnormal state, the detection unit 15 performs notification processing such as notifying the car C that an abnormal state is detected or notifying a mobile terminal of a driver or a business entity performing maintaining of the car C registered in advance.

Herein, the model storage unit 19 and the detection unit 15 described above may be mounted in the car C. More specifically, the detection unit 15 may be constructed by mounting an information processing device including an arithmetic device and a storage device in the car C, forming the model storage unit 19 storing the state detection model stored in the storage device, and causing the arithmetic device to execute programs. This allows the car C to detect the state of the car C by inputting the newly measured measurement value data into the state detection model by the detection unit 15.

### [Operation]

Operations of the information processing device 10 described above will be described mainly referring to the flowcharts in FIGS. 6 and 7. First, an operation of generating the state detection model is described with reference to the flowchart in FIG. 6.

The information processing device 10 acquires the measurement value data and the situation data from two or more of the cars C (Step S1). The measurement value data are values each representing the performance of each of the plurality of pieces of equipment equipped in the car C and include a vehicle speed, an acceleration, an engine speed, a fuel injection amount, a remaining battery level, a tire pressure, and the like, for example. The situation data are data each representing the situation of the car C when the measurement value data are measured and include weather, a temperature, brightness, a time zone, a road surface situation, a steering direction by a driver, dozing of a driver, and the like, for example.

Subsequently, the information processing device 10 classifies the measurement value data on the basis of the situation data (Step S2). At this time, the information processing device 10 and the classification unit 12 sort and classify the measurement value data made to correspond to the situation data for each of the situations of the car C specified by the situation data. For example, the information processing device 10 classifies, with respect to the classification A in which the situation data is “Weather: clear”, the classification B in which the situation data is “Road surface: bad road”, and the situation data C is “Driver: dozing”, the measurement value data measured in each of the situations as indicated by the black circles in FIG. 3.

Subsequently, the information processing device 10 selects the measurement value data to be used as the training data from each of the classifications (Step S3). At this time, the information processing device 10 substantially equally select the measurement value data from each of the classifications. More specifically, the information processing device 10 selects almost the same number of the measurement value data from each of the classifications even when the number of the measurement value data belonging to each of the classifications is different as illustrated in FIGS. 3 and 4. The information processing device 10 is not necessarily limited to selecting substantially the same number of the measurement value data from each of the classifications, and may select the measurement value data of the number corresponding to the ratio among the classifications set for each of the classifications.

Subsequently, the information processing device 10 performs machine learning with the measurement value data selected from each of the classifications as the training data and creates the state detection model (Step S4). This allows the generation of a model equally considering every situation of the car C, enabling an improvement of the accuracy of such a model.

Next, an operation of detecting the state of the car C using the state detection model generated as described above will be described with reference to the flowchart in FIG. 7.

Whenever the car C newly measures the measurement value data, the information processing device 10 acquires the new measurement value data from the car C (Step S11). Then the information processing device 10 inputs the new measurement value data into the state detection model (Step S12) and detects state the state of the car C from an output result of the state detection model (Step S13). For example, the information processing device 10 detects whether the car C is in a normal state or an abnormal state. This allows the information processing device 10 to detect the state of the car C with high accuracy.

### <Second Exemplary Embodiment>

Next, a second exemplary embodiment of the present invention will be described with reference to FIGS. 8 to 10. FIGS. 8 and 9 are block diagrams each illustrating a configuration of a learning device in the second exemplary embodiment. FIG. 10 is a flowchart illustrating operations of the learning device. This exemplary embodiment describes the outline of the configurations of the information processing device and the information processing method described in the above-described exemplary embodiment.

First, a hardware configuration of a learning device 100 in this exemplary embodiment will be described with reference to FIG. 8. The learning device 100 is configured of a typical information processing device, being equipped with a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing the program group 104
Drive device 106 performing reading and writing on a storage medium 110 outside the information processing device
Communication interface 107 connected to a communication network 111 outside the information processing device
Input/output interface 108 for performing input/output of data
Bus 109 connecting the constituent elements

The learning device 100 can construct and be equipped with a classification unit 121, a selection unit 122, and a learning unit 123 illustrated in FIG. 9 through acquisition of the program group 104 by the CPU 101 and execution thereof by the CPU 101. The program group 104 is stored in advance in the storage device 105 or the ROM 102, and is loaded to the RAM 103 by the CPU 101 as needed. Further, the program group 104 may be supplied to the CPU 101 via the communication network 111, or the program may be stored in advance on the storage medium 110 and read out by the drive device 106 and supplied to the CPU 101. However, the classification unit 121, the selection unit 122, and the learning unit 123 described above may be constructed by electronic circuits dedicated for realizing such means.

FIG. 8 illustrates an example of the hardware configuration of the information processing device that is the learning device 100. The hardware configuration of the information processing device is not limited to that described above. For example, the information processing device may be configured of part of the configuration described above, such as without the drive device 106.

Then, the learning device 100 executes the learning method illustrated in the flowchart of FIG. 10 by the functions of the classification unit 121, the selection unit 122, and the learning unit 123 constructed by programs as described above.

As illustrated in FIG. 10, the learning device 100 executes processing of:
classifying the measurement value data measuring performance of the object on the basis of the situation data each representing the situation of the object when the measurement value data are measured (Step S101);
selecting the measurement value data from each of the classifications according to the number of the measurement value data for each of the classifications (Step S102); and
performing the machine learning on the basis of the selected measurement value data (Step S103).

With the configurations described above, in the present invention, the state detection model equally considering every situation of the object can be generated, enabling an improvement of the accuracy of such a model.

Note that the program described above can be supplied to a computer by being stored on non-transitory computer readable media of various types. The non-transitory computer readable media include tangible storage media of various types. Examples of the non-transitory computer readable media include a magnetic recording medium (for example, flexible disk, magnetic tape, and hard disk drive), a magneto-optical recording medium (for example, magneto-optical disk), a CD-ROM (Read Only Memory). a CD-R, a CD-R/W, and a semiconductor memory (for example, mask ROM, PROM (Programmable ROM), and EPROM (Erasable PROM), a flash ROM, and a RAM (Random Access Memory)). The program described above may also be supplied to a computer by being stored on the transitory computer readable media of various types. Examples of the transitory computer readable media include electric signals, optical signals, and electromagnetic waves. The transitory computer readable media can be supplied to a computer via a wired communication channel such as an electric wire and an optical fiber, or a wireless communication channel.

While the present invention has been described with reference to the exemplary embodiments described above, the present invention is not limited to the above-described exemplary embodiments. The form and details of the present invention can be changed within the scope of the present invention in various manners that can be understood by those skilled in the art. Further, at least one or more of the functions of the classification unit 121, the selection unit 122, and the learning unit 123 described above may be executed by an information processing device installed and connected to any location on the network, i.e., so-called cloud computing.

### <Supplementary Notes>

The whole or part of the exemplary embodiments disclosed above can be described as, but not limited to, the following supplementary notes. Hereinafter, outlines of the configurations of a learning method, a learning device, and a program according to the present invention will be described. However, the present invention is not limited to the configurations described below.

### (Supplementary Note 1)

A learning method including:
classifying measurement value data measuring performance of an object on a basis of situation data each representing a situation of the object when the measurement value data are measured,
selecting the measurement value data from each of the classifications according to the number of the measurement value data for each of the classifications, and
performing machine learning on a basis of the selected measurement value data.

### (Supplementary Note 2)

The learning method according to supplementary note 1, further including: classifying the measurement value data measuring performance of each of a plurality of pieces of equipment equipped in the object on a basis of the situation data.

### (Supplementary Note 3)

The learning method according to supplementary note 1 or 2, further including: classifying the measurement value data on a basis of external situation data each representing a situation of the object due to an external situation of the object.

### (Supplementary Note 4)

The learning method according to any one of supplementary notes 1 to 3, further including:
classifying the measurement value data on a basis of internal situation data each representing a situation of the object due to an internal situation of the object.

### (Supplementary Note 5)

The learning method according to any one of supplementary notes 1 to 4, further including:
substantially equally selecting the measurement value data from each of the classifications.

### (Supplementary Note 6)

The learning method according to any one of supplementary notes 1 to 5, further including:
selecting, according to a ratio set for each of the classifications, the measurement value data from each of the classifications.

(Supplementary Note 7)

The learning method according to any one of supplementary notes 1 to 6, wherein
the object is a car, and
when the measurement value data are classified on a basis of the situation data, the situation data represents at least one of situations of a situation of a road surface where the car travels and weather at the time of traveling.

### (Supplementary Note 8)

The learning method according to any one of supplementary notes 1 to 7, wherein
the object is a car, and
when the measurement value data are classified on a basis of the external situation data each representing the situation of the car due to the external situation of the car, the external situation data is at least one of weather, a temperature, brightness, a time zone, a road surface situation, a steering direction by a driver, and dozing of a driver.

### (Supplementary Note 9)

The learning method according to any one of supplementary notes 1 to 8, wherein
the object is a car, and
when the measurement value data are classified on a basis of the internal situation data each representing the situation of the car due to the internal situation of the car, the internal situation data is at least one of a car type, a model number, a purchase date, a repair history, and a total travel distance of the car.

### (Supplementary Note 10)

A method for detecting a state using the learning method according to any one of supplementary notes 1 to 9, including:
inputting the measurement value data newly measured from the object into a model generated by performing the machine learning and detecting a state of the object according to an output from the model.

### (Supplementary Note 11)

A learning device including:
a classification unit configured to classify measurement value data measuring performance of an object on a basis of situation data each representing a situation of the object when the measurement value data are measured;
a selection unit configured to select the measurement value data from each of the classifications according to the number of the measurement value data for each of the classifications; and
a learning unit configured to perform machine learning on a basis of the selected measurement value data.

### (Supplementary Note 12)

The learning device according to supplementary note 11, wherein
the classification unit is configured to classify the measurement value data measuring performance of each of a plurality of pieces of equipment equipped in the object on a basis of the situation data.

### (Supplementary Note 13)

The learning device according to supplementary note 11 or 12, wherein
the classification unit is configured to classify the measurement value data on a basis of external situation data each representing a situation of the object due to an external situation of the object.

### (Supplementary Note 14)

The learning device according to any one of supplementary notes 11 to 13, wherein
the classification unit is configured to classify the measurement value data on a basis of internal situation data each representing a situation of the object due to an internal situation of the object.

### (Supplementary Note 15)

The learning device according to any one of supplementary notes 11 to 14, wherein
the selection unit is configured to substantially equally select the measurement value data from each of the classifications.

### (Supplementary Note 16)

The learning device according to any one of supplementary notes 11 to 15, wherein
the selection unit is configured to select, according to a ratio set for each of the classifications, the measurement value data from each of the classifications.

### (Supplementary Note 17)

The learning device according to any one of supplementary notes 11 to 16, wherein
the object is a car, and
when the measurement value data are classified on a basis of the situation data, the situation data represents at least one of situations of a situation of a road surface where the car travels and weather at the time of traveling.

### (Supplementary Note 18)

The learning device according to any one of supplementary notes 11 to 17, wherein
the object is a car, and
when the measurement value data are classified on a basis of the external situation data each representing the situation of the car due to the external situation of the car, the external situation data is at least one of weather, a temperature, brightness, a time zone, a road surface situation, a steering direction by a driver, and dozing of a driver.

### (Supplementary Note 19)

The learning device according to any one of supplementary notes 11 to 18, wherein
the object is a car, and
when the measurement value data are classified on a basis of the internal situation data each representing the situation of the car due to the internal situation of the car, the internal situation data is at least one of a car type, a model number, a purchase date, a repair history, and a total travel distance of the car.

### (Supplementary Note 20)

A state detection device including the learning device according to any one of supplementary notes 11 to 19, including:
a detection unit configured to input the measurement value data newly measured from the object into a model generated by performing the machine learning and detect a state of the object according to an output from the model.

### (Supplementary Note 21)

A computer-readable medium storing thereon a program for causing a computer to execute processing to:
classify measurement value data measuring performance of an object on a basis of situation data each representing a situation of the object when the measurement value data are measured;
select the measurement value data from each of the classifications according to the number of the measurement value data for each of the classifications; and perform machine learning on a basis of the selected measurement value data.

### Reference Signs List

10 information processing device
11 acquisition unit
12 classification unit
13 selection unit
14 learning unit
15 detection unit
16 measurement value data storage unit
17 situation data storage unit
18 training data storage unit
19 model storage unit
C car
100 learning device
101 CPU
102 ROM
103 RAM
104 program group
105 storage device
106 drive device
107 communication interface
108 input/output interface
109 bus
110 storage medium
111 communication network
121 classification unit
122 selection unit
123 learning unit

What is claimed is:

1. A learning method comprising:
classifying measurement value data measuring performance of an object on a basis of situation data each representing a situation of the object when the measurement value data are measured,
selecting the measurement value data from each of the classifications according to a number of the measurement value data for each of the classifications, and
performing machine learning on a basis of the selected measurement value data.

2. The learning method according to claim 1, further comprising:
classifying the measurement value data measuring performance of each of a plurality of pieces of equipment equipped in the object on a basis of the situation data.

3. The learning method according to claim 1, further comprising:
classifying the measurement value data on a basis of external situation data each representing a situation of the object due to an external situation of the object.

4. The learning method according to claim 1, further comprising:
classifying the measurement value data on a basis of internal situation data each representing a situation of the object due to an internal situation of the object.

5. The learning method according to claim 1, further comprising:
substantially equally selecting the measurement value data from each of the classifications.

6. The learning method according to claim 1, further comprising:
selecting, according to a ratio set for each of the classifications, the measurement value data from each of the classifications.

7. The learning method according to claim 1, wherein
the object is a car, and
when the measurement value data are classified on a basis of the situation data, the situation data represents at least one of situations of a situation of a road surface where the car travels and weather at the time of traveling.

8. The learning method according to claim 1, wherein
the object is a car, and
when the measurement value data are classified on a basis of the external situation data each representing the situation of the object due to the external situation of the car, the external situation data is at least one of weather, a temperature, brightness, a time zone, a road surface situation, a steering direction by a driver, and dozing of a driver.

9. The learning method according to claim 1, wherein
the object is a car, and
when the measurement value data are classified on a basis of the internal situation data each representing the situation of the car due to the internal situation of the car, the internal situation data is at least one of a car model, a model number, a purchase date, a repair history, and a total travel distance of the car.

10. A method for detecting a state using the learning method according to claim 1, comprising:
inputting the measurement value data newly measured from the object into a model generated by performing the machine learning and detecting a state of the object according to an output from the model.

11. A learning device comprising:
at least one memory configured to store instructions; and
at least one processer configured to execute the instructions to:
classify measurement value data measuring performance of an object on a basis of situation data each representing a situation of the object when the measurement value data are measured;
select the measurement value data from each of the classifications according to a number of the measurement value data for each of the classifications; and
perform machine learning on a basis of the selected measurement value data.

12. The learning device according to claim 11, wherein
the at least one processer configured to execute the instructions to classify the measurement value data measuring performance of each of a plurality of pieces of equipment equipped in the object on a basis of the situation data.

13. The learning device according to claim 11, wherein
the at least one processer configured to execute the instructions to
classify the measurement value data on a basis of external situation data each representing a situation of the object due to an external situation of the object.

14. The learning device according to claim 11, wherein
the at least one processer configured to execute the instructions to
classify the measurement value data on a basis of internal situation data each representing a situation of the object due to an internal situation of the object.

15. The learning device according to claim 11, wherein
the at least one processer configured to execute the instructions to
substantially equally select the measurement value data from each of the classifications.

16. The learning device according to claim 11, wherein
the at least one processer configured to execute the instructions to
select, according to a ratio set for each of the classifications, the measurement value data from each of the classifications.

17-20. (canceled)

21. A non-transitory computer-readable medium storing thereon a program comprising instructions for causing a computer to execute processing to:
classify measurement value data measuring performance of an object on a basis of situation data each representing a situation of the object when the measurement value data are measured;
select the measurement value data from each of the classifications according to a number of the measurement value data for each of the classifications; and
perform machine learning on a basis of the selected measurement value data.
